(19) United States
(12) Patent Application Publication
(10) Pub. No.: US 2017/0273313 A1
(43) Pub. Date: Sep. 28, 2017

(54) POLYMER COATINGS CONTAINING MORINGA OIL AND NEEM OIL AND METHODS OF MAKING AND USING SAME

(71) Applicant: MAGELLAN COMPANIES, INC., MT. PLEASANT, SC (US)

(72) Inventor: SAMUEL G. SEABROOK, Jr., MT. PLEASANT, SC (US)

(21) Appl. No.: 15/510,903

(22) PCT Filed: Sep. 8, 2015
(86) PCT No.: PCT/US15/48793

§ 371 Date: Mar. 13, 2017

Related U.S. Application Data
(60) Provisional application No. 62/057,517, filed on Sep. 30, 2014.
(60) Provisional application No. 62/111,273, filed on Feb. 3, 2015.

(51) Int. Cl. A01N 65/26; B05D 7/24; C09D 157/06; C09D 5/14; A01N 65/08; C09J 7/02

(52) U.S. Cl. CPC A01N 65/26; A01N 65/08; C09J 7/02; C09D 157/06; C09D 5/14; B05D 7/24

(57) ABSTRACT

This disclosure relates to compositions comprising a vehicle such as a polymer base, moringa oil and neem oil. The combination of the two oils is in an amount sufficient to prevent the establishment or proliferation of a microorganism, such as a mildew, on the surface of an inanimate object. The moringa oil and neem oil combination can be advantageously admixed with a paint base, a solvent system, or other vehicle base for the treatment of wood, dry wall, or other porous or non-porous surface that is susceptible to a biological infestation.

### CROSS-REFERENCE TO RELATED APPLICATIONS

This application claims priority to and the benefit of U.S. Provisional Application 62/057,517 titled “POLYMER COATINGS CONTAINING PHYTOCHEMICAL AGENTS AND METHODS FOR MAKING AND USING SAME” filed Sep. 30, 2014, and to U.S. Provisional Application 62/111,273 titled “POLYMER COATINGS CONTAINING PHYTOCHEMICAL AGENTS AND METHODS FOR MAKING AND USING SAME” filed Feb. 3, 2015, the entire disclosures of which are incorporated herein by reference.

### FIELD OF THE DISCLOSURE

The present disclosure generally relates to compositions and methods employing such compositions to prevent biological growth on susceptible surfaces. The present disclosure specifically relates to coatings that incorporate moringa oil, neem oil, and a solid or liquid vehicle. This disclosure also relates to methods of using the compositions described herein.

### BACKGROUND

Fungal growth on indoor and outdoor surfaces is a major environmental concern affecting home, work and recreational environments. Not only can fungus (e.g., mold, mildew) be unsightly on exposed surfaces, it can destroy wood, fiber, and other materials if left untreated, causing severe damage to buildings and other structures and equipment. Over the past few years it has become increasingly apparent that exposure to certain fungi or their spores can seriously impact the health of humans, pets and other animals.

Paints and paint films or coatings are known to be vulnerable to mold contamination due to the presence of organic cellulosic thickeners, surfactants and defoamers, and which can serve as a source of food for fungus cells. Some of these components are casein, acrylic, polyvinyl and other carbon polymers. For example, latex is a water-dispersed binder comprising a carbon polymer. Even inside a paint can, certain fungi (e.g., yeasts) can convert enough carbon-containing food sources to carbon dioxide to swell or even explode the can. Fungi can also discolor and reduce the viscosity of the paint, and produce foul odors. Both in-can preservation of paints and protection of the end use paint films, and the surfaces they cover, from mold, mildew and yeasts is necessary. Additionally, exposed organic surfaces such as wood railings, fences, walls, and other architectural features are susceptible to fungus-generated discoloration and deterioration. Under high moisture conditions, solid surfaces can also support other undesirable biological growth such as algae.

To combat biological infestations of such as fungi and algae, a variety of coating materials have been formulated to include organic or inorganic chemicals to discourage or prevent the growth of such as mildew on the paint film. Ideally, fungicides or mildewcides slowly leach out of the paint to the surface, and maintain their inhibitory properties for the life of the paint film and cause little or no harm to the environment. In practice, however, the antifungal properties of most coating compositions in use today persist for variable lengths of time, depending on the amount of exposure to the elements, abrasion and erosion.

Due to environmental and safety concerns, therefore, there is increasing pressure on the coatings industry to eliminate some of the more effective but more toxic chemical preservatives from paints and other coating compositions. At the same time, consumers wish to avoid purchasing spoiled or poorly performing products. Thus, there is a continuing need in the industry for safe and effective alternatives to conventional agents for preventing or reducing biological infestations of exposed surfaces susceptible to such contamination.

### SUMMARY

One aspect of the disclosure, therefore, encompasses embodiments of a bioactive composition comprising moringa oil and neem oil in a liquid or non-liquid in an amount sufficient to inhibit or prevent a biological infestation or growth on a surface coated with said bioactive composition, wherein the biological infestation or growth comprises a fungal species, an algal species, a bacterial species, or any combination thereof.

In some embodiments of this aspect of the disclosure, each of the moringa oil and the neem oil may independently comprise between about 0.001% to about 30.0% by weight, of the composition.

In some embodiments of this aspect of the disclosure, the moringa oil and the neem oil may be in a ratio of: between about 10:1 to about 1:10 by weight, between about 5:1 to about 1:5 by weight; or between about 2:1 to about 1:2 by weight.

In some embodiments of this aspect of the disclosure, moringa oil and the neem oil may in a ratio of about 1:1 by weight

In some embodiments of this aspect of the disclosure, the composition may be a coating of a surface of an inanimate object.

In some embodiments of this aspect of the disclosure, the liquid or non-liquid vehicle may comprise a polymer in an amount effective to form the coating when the composition is applied to the surface.

In some embodiments of this aspect of the disclosure, the liquid or non-liquid vehicle may be a paint.

In some embodiments of this aspect of the disclosure, composition may further comprise at least one of a binder in an amount effective to enhance adherence of the coat formed from the composition and a pigment or dye component in an amount effective to impart a color to the coat.

In some embodiments of this aspect of the disclosure, the at least one liquid vehicle may be selected from the group consisting of an organic solvent, a thinner, a diluent, a plasticizer, and water, and wherein, when the vehicle includes water, the composition may further comprise at least one surfactant.

In some embodiments of this aspect of the disclosure, the composition may further comprise at least one of a wetting agent, a buffer, a rheology modifier, a defoamer, a catalyst, an anti-skinning agent, a light stabilizer, a corrosion inhibitor, a dehydrator, an electrical agent, and an anti-insect agent.

In some embodiments of this aspect of the disclosure, the coating may be at least one of a paint and a clear coating, and wherein each of the paint and the clear coating may independently comprise a lacquer, a varnish, a shellac, a stain, a water repellent coating, or a combination thereof.

In some embodiments of this aspect of the disclosure, the non-liquid vehicle may be an adhesive, a grouting mix, a solid or semi-solid polymer, an elastomeric polymer, an organic solid, or an inorganic solid.

In some embodiments of this aspect of the disclosure, the non-liquid vehicle may be an elastomeric polymer configured as a seal for a refrigerator door.

In some embodiments of this aspect of the disclosure, the non-liquid vehicle can be a flexible tape or sheet and optionally further comprising an adhesive layer, wherein the flexible sheet or tape and the optional adhesive can each independently comprise an elastomeric polymer comprising moringa oil and neem oil in amounts sufficient to inhibit or prevent a biological infestation on at least one of a surface of the flexible tape or sheet, the adhesive layer, or within the adhesive layer.

In some embodiments of this aspect of the disclosure, the coating may be a multi-coat system comprising a plurality of superimposed layers, wherein each layer independently comprises moringa oil, neem oil, or a mixture of moringa oil and neem oil.

In some embodiments of this aspect of the disclosure, the coating may be an architectural coating.

In some embodiments of this aspect of the disclosure, the architectural coating may comprise a wood coating, a masonry coating, an artist's coating, a grouting mix, or a combination thereof.

In some embodiments of this aspect of the disclosure, the binder may comprise an oil, an alkyd, an oleoresinous binder, a fatty acid epoxide ester, a polyester binder, an urethane binder, a phenolic resin, an epoxy resin, a polyhydroxyether binder, an acrylic resin, a polyvinyl binder, a rubber resin, a bituminous binder, a polysulfide binder, a silicone binder, or a combination thereof.

In some embodiments of this aspect of the disclosure, the coating may comprise a polyol, an amine, an epoxide, a silicone, a vinyl, a phenolic, a triacrylate, an alkyd resin, an amino resin, a blown oil, an epoxy resin, a polyamide, a polyvinyl resin, an amino resin a phenolic resin, a polyamide, a ketimine, an aliphatic amine, a cycloaliphatic epoxy binder, a polyol, an epoxide, a polyurethane comprising an isocyanate moiety, an alkyd, an urethane, or a combination thereof.

In some embodiments of this aspect of the disclosure, the solvent may comprise at least one of a hydrocarbon, an oxygenated compound, a chlorinated hydrocarbon, a nitrated hydrocarbon, wherein the hydrocarbon can be an aliphatic hydrocarbon, a cycloaliphatic hydrocarbon, a terpene, an aromatic hydrocarbon, or a combination thereof, the aliphatic hydrocarbon is at least one of a petroleum ether, pentane, hexane, heptane, isododecane, a kerosene, a mineral spirit, a VMP naphthas, the cycloaliphatic hydrocarbon is at least one of cyclohexane, methylcyclohexane, ethylcyclohexane, tetrahydronaphthalene, decahydronaphthalene, the terpene is at least one of wood turpentine oil, pine oil, α-pinene, β-pinene, dipentene, D-limonene, the aromatic hydrocarbon is at least one of benzene, toluene, ethylbenzene, xylene, cumene (isopropylbenzene), a type I high flash aromatic naphtha, a type II high flash aromatic naphtha, mesitylene, pseudocumene, cymol, styrene, the oxygenated compound is an alcohol, an ester, a glycol ether, a ketone, an ether, and the alcohol is at least one of methanol, ethanol, propanol, isopropanol, 1-butanol, isobutanol, 2-butanol, tert-butanol, amyl alcohol, isoamyl alcohol, hexanol, methylisobutylcarbinol, 2-ethylbutanol, isooctyl alcohol, 2-ethylhexanol, isodecanol, cylcohexanol, methylcyclohexanol, trimethylcyclohexanol, benzyl alcohol, methylbenzyl alcohol, furfuryl alcohol, tetrahydrofurfuryl alcohol, diacetone alcohol, trimethylcyclohexanol.

Another aspect of the disclosure encompasses embodiments of a method of providing or enhancing resistance to a biological infestation or growth on a surface of an inanimate object, wherein the biological infestation or growth may comprise a fungal species, an algal species, a bacterial species, or any combination thereof, said method comprising applying a coating on the surface of the inanimate object, wherein the coating may comprise a film or liquid coating comprising moringa oil and neem oil, wherein each of the moringa oil and the neem oil are in amounts that synergistically inhibit the biological infestation or growth of the coated surface.

In the embodiments of this aspect of the disclosure, the composition can be a bioactive composition comprising moringa oil and neem oil in a liquid or non-liquid vehicle in an amount sufficient to inhibit or prevent the biological infestation or growth on a surface coated with the bioactive composition.

In some embodiments of this aspect of the disclosure, the coating may comprise a plurality of superimposed layers, each layer independently comprising a liquid or solid vehicle and moringa oil or neem oil.

In some embodiments of this aspect of the disclosure, the method may further comprise adding moringa oil and neem oil to at least one volume of a solid or liquid vehicle, wherein the amount of each oil is effective in reducing the biological infestation or growth on the surface.

In some embodiments of this aspect of the disclosure, the inanimate object may be at least partially porous, the method comprising impregnating at least a portion of said object with the composition comprising moringa oil and neem oil.

In some embodiments of this aspect of the disclosure, the object may comprise at least one porous, semi-porous or non-porous material chosen from the group consisting of wall board, ceiling tile, paper, fabric, concrete, stone, brick, wood, plastic, ceramic, and leather.

Still another aspect of the disclosure encompasses embodiments of a fungus-resistant or bacterium-resistant coated surface of an inanimate object, wherein said surface is resistant to a biological infestation or growth thereon and comprising a film or coating formed from a bioactive composition comprising moringa oil and neem oil in a liquid or non-liquid vehicle in an amount sufficient to inhibit or prevent the biological infestation or growth.

### BRIEF DESCRIPTION OF THE DRAWINGS

The following detailed description, given by way of example, but not intended to limit the disclosure solely to the specific embodiments described, may best be understood in conjunction with the accompanying drawings, in which:

FIG. 1 illustrates the ability of a polymer composition comprising moringa oil and neem oil according to the disclosure to substantially eliminate fungal growth on an exposed wood surface.

FIG. 2A illustrates the ability of a composition comprising moringa oil and neem oil according to the disclosure to substantially inhibit fungal growth on an exposed wood surface even after environmental (marine area) exposure of the wood for 26 months.

FIG. 2B illustrates the fungal growth on a wood surface not treated with a moringa oil-neem oil composition according to the disclosure after environmental (marine area) exposure of the wood for 26 months.

FIG. 3 illustrates the ability of a composition comprising moringa oil and neem oil according to the disclosure to substantially inhibit algal growth on an exposed wood surface.

### DETAILED DESCRIPTION OF THE DISCLOSURE

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of medicine, organic chemistry, biochemistry, molecular biology, pharmacology, and the like, which are within the skill of the art. Such techniques are explained fully in the literature.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the following terms have the meanings ascribed to them unless specified otherwise. In this disclosure, “comprises,” “comprising,” “containing” and “having” and the like can have the meaning ascribed to them in U.S. patent law and can mean “includes,” “including,” and the like; “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. patent law, allowing for the presence of more than that which is recited so long as basic or novel characteristics of that which is recited is not changed by the presence of more than that which is recited, but excludes prior art embodiments.

### Definitions

The term “neem oil” as used herein refers to a cold-pressed product obtained from seeds of the Neem tree (Azadirachta indica) which is a tropical evergreen tree native to India and also found in other Southeast Asian and African countries. Cold-pressed neem oil also contains steroids, fatty acids, and a number of essential oils. Neem oil varies in color; it can be golden yellow, yellowish brown, reddish brown, dark brown, greenish brown or bright red. It has a rather strong odor that is said to combine the odors of peanut and garlic. It is composed mainly of triglycerides and contains many triterpenoid compounds that are responsible for a bitter taste. It is hydrophobic in nature; in order to emulsify it in water for application purposes, it must be formulated with appropriate surfactants. Azadirachtin is the most well-known and studied triterpenoid in neem oil. The azadirachtin content of neem oil varies from 300 ppm to over 2500 ppm depending on the extraction technology and quality of the neem seeds crushed. Nimbin is another triterpenoid that has been credited with some of neem oil's properties as an antiseptic, antifungal, antipyretic and antihistamine. Neem oil also contains several sterols, including (campesterol, (3-sitosterol, and stigmasterol). The average composition of neem oil comprises the fatty acids linoleic acid, oleic acid, hexadecanoic acid, octadecanoic acid, alpha-linolenic acid, 9-hexadecenoic acid

The term “moringa oil” as used herein refers to a composition of vegetable oil triglycerides derived from Moringa oleifera kernels. Moringa oil typically contains oleic acids, palmitic acid, stearic acid, and behenic acid. Moringa oleifera is the most widely cultivated species of the genus Moringa, which is the only genus in the family Moringaceae. English common names include: moringa, drumstick tree (from the appearance of the long, slender, triangular seed-pods), horseradish tree (from the taste of the roots, which resembles horseradish), ben oil tree, or benzoil tree. Moringa oil is derived from the seeds. It is a fast-growing, drought-resistant tree, native to the southern foothills of the Himalayas in northwestern India, and widely cultivated in tropical and subtropical areas where its young seed pods and leaves are used as vegetables. It can also be used for water purification and hand washing, and is sometimes used in herbal medicine. Mature seeds yield 38-40% edible oil called ben oil from its high concentration of behenic acid. The refined oil is clear and odorless, and resists rancidity.

The term “vehicle” as used herein refers to any medium miscible with, or with which the moringa oil and neem oil may be admixed. A “vehicle” of the compositions of the disclosure may be liquid (including, but not limited to, an aliphatic or aromatic, substituted or unsubstituted hydrocarbon, or a mixture of said hydrocarbons, an oxygenated organic compound including, but not limited to alcohols, carboxylic acids, ketones, ethers, and the like, and to any combination thereof). For example, but not intending to be limiting, a liquid vehicle for advantageous incorporation into the compositions of the disclosure may be: xylene, toluene, octane, hexane, cyclohexane, ethanol, methanol, propanol, isopropanol, acetone, diethyl ketone, methyl ethyl ketone, and any combination thereof. Of particular advantage are liquid vehicles that are well known in the art as solvents for paints and varnishes and to which the moringa oil and the neem oil may be admixed. The liquid vehicles of the disclosure may further encompass other compounds such as, but not limited to, a polymer or polymerisable monomers that may generate a coating or film comprising the moringa oil and neem oil. Especially advantageous in the context of the disclosure are polymers or monomers typically incorporated into paints and varnishes.

The term “vehicle” as used herein further encompasses a semi-solid compositions such as a grouting compound or an adhesive that, while not fluid, may be moldable or spreadable and thereby suitable for retaining and distributing the moringa oil and the neem oil over a surface that is to be afforded protection from a biological, including fungal or bacterial, infestation. It is further considered that the moringa oil and the neem oil may be admixed with a solid material such as calcium carbonate, iron oxide, kaolin, clay, titanium dioxide, alumina trihydrate, pyrophyllite, quartz, silica, fumed silicas, precipitated silicas, silicates, barium sulfate, antimony oxide, mica, calcium sulfate, magnesium hydroxide, feldspar, nepheline syenite, carbon black filler, titanates, talc, gypsum, silex, wollastonite, bagasse, coconut hull/fiber, cork, corn, cotton-based, filsonite, nutshell flour, rice hull, sisal/hemp, soybean, starch wood flour, and the like, and combinations thereof, such that the resulting bioactive composition is a paste, a moistened powder, or the like.

The term “inanimate object” as used herein refers to any non-living object having a surface that is required to be protected from a biological infestation or colonization. The term refers to organic and inorganic objects or materials including, but not limited to, organic materials derived from former living animal or plant sources. Accordingly, the term inanimate object as referred to by the present disclosure includes such as wood, wood composites, wood components, wooden architectural features, whether formed entirely of wood or where wood is a component, fabric, wall surfaces such as plaster, dry wall, gypsum, painted surfaces, paper or paper-coated surfaces and the like. A “fungal-prone material” is a substance that is capable of serving as a food source for a fungus, or is a material that contains one or more such substance. For example, in the context of a paint or coating composition, a fungal-prone material may be a binder containing a carbon-based polymer that serves as a nutrient for a fungus.

The term “fungus (pl: fungi)” as used herein refers to true fungi, molds and mildews that are eukaryotic organisms that have cell walls, similar to plants, but do not contain chlorophyll. There are between 100,000-200,000 species of fungi, mold and mildew known. The term “fungus” as used herein includes multicellular and unicellular organisms in the fungus family, including the true fungi, molds, mildews and yeasts. “Mold” is sometimes used as a synonym for fungi, where the context permits, especially when referring to indoor contaminants. However, the term “mold” also, and more specifically, denotes certain types of fungi. For example, the plasmodial slime molds, the cellular slime molds, water molds, and the everyday common mold. True molds are filamentous fungi consisting of the mycelium, specialized, spore-bearing structures called conidiophores, and conidia (spores). “Mildew” is another common name for certain fungi, including the powdery mildews and the downy mildews. “Yeasts” are unicellular members of the fungus family. For the purposes of the present disclosure, where any of the terms fungus, mold, mildew and yeast is used, the others are implied where the context permits.

Fungal colonies typically take on filamentous form, having long filament-like cells called hyphae that can grow into an intertwining network called the mycelium. A mycelium can be visible to the naked eye, appearing as unsightly fuzzy green, bluish-gray or black spots, for example. When conditions for growth are less favorable, many varieties of fungi can respond by forming spores on specialized hyphal cells. Spores are the primary means for dispersal and survival of fungi, and can remain dormant for months or even years. They are also capable of withstanding extremely adverse conditions, to germinate and flourish again when environmental variables such as light, oxygen levels, temperature, and nutrient availability again become favorable. Thick-walled spores are substantially more resistant to common disinfectant agents than are the thinner-walled vegetative fungal cells. According to the U.S. Environmental Protection Agency, there is no practical way to eliminate all mold and mold spores in the indoor environment.

Fungi grow as saprophytes, i.e., in a suitable moist environment they are able to decompose organic matter to obtain the nourishment needed for growth. Building and decorative materials such as wood, paper-coated wallboard, wallpaper, fabrics, carpet and leather can provide the necessary organic matter. Today, an especially problematic fungal genus sometimes found in buildings that have excess indoor moisture is Stachybotrys. Stachybotrys chartarum, commonly found in nature growing on cellulose-rich plant materials, has often been found in water-damaged building materials, such as ceiling tiles, wallpaper, sheet-rock and cellulose resin wallboard (fiberboard). Depending on the particular conditions of temperature, pH and humidity in which the mold is growing, Stachybotrys may produce mycotoxins.

Other common fungi that can grow in residential and commercial buildings are Aspergillus species (sp.), Penicillium sp., Fusarium sp., Alternaria dianthicola, Aureobasidium pullulans (Pullularia pullulans), Phoma pigmentivora, and Cladosporium sp. The moist indoor environment that promotes growth of these fungi can arise from water damage, excessive humidity, water leaks, condensation, water infiltration, or flooding, in some cases due to defects in building construction, faulty mechanical system design, and/or operational problems. Even modern homes and commercial buildings are not immune to fungal invasion despite the use of technologically-advanced building materials and more energy efficient construction and operation than in buildings of the past. Modern homes tend to be less well ventilated, and although the use of air conditioning reduces humidity making it harder for mold to grow on humid surfaces, central air conditioning systems can facilitate the spread of mold spores throughout a home as well as being susceptible to mold growth themselves. Increased use of paper products in homes and commercial buildings today further encourages mold growth. Heavy contamination of indoor or outdoor surfaces by dirt and/or oil can also provide a food source for a fungus. Vulnerable structures and materials that are difficult to access for cleaning, or for which cleaning is neglected, are particularly vulnerable to attack by fungi. Fungi are also known to contaminate stored paints, fuels, and many other industrial products.

The term “alga(ae)” as used herein refers to unicellular and multicellular algae. Examples of such algae include, but are not limited to, a rhodophyte, chlorophyte, heterokontophyte, tribophyte, glaucophyte, chlorarachniophyte, euglenoid, haptophyte, cryptomonad, dinoflagellum, phytoplankton, and the like, and combinations thereof, including in the classes Chlorophyceae and/or Haptophyta. Specific species can include, but are not limited to, Neoch/oris oleoabundans, Scenedesmus dimorphus, Scenedesmus quadricauda, Euglena gracilis, Phaeodactylum tricornutum, Pleurochrysis carterae, Prymnesium parvum, Tetraselmis chui, and Chlamydomonas reinhardtii, Chlorella pyrenoidosa, Chlorococcum oleofaciens, Anabaena flosaquae, Nostoc commune, Dunaliella parva. Additional or alternate algal sources can include one or more microalgae of the Achnanthes, Amphiprora, Amphora, Ankistrodesmus, Asteromonas, Boekelovia, Borodinella, Botryococcus, Bracteococcus, Chaetoceros, Carteria, Chlamydomonas, Chlorococcum, Chlorogonium, Chlorella, Chroomonas, Chrysosphaera, Cricosphaera, Crypthecodinium, Cryptomonas, Cyclotella, Dunaliella, Ellipsoidon, Emiliania, Eremosphaera, Ernodesmius, Euglena, Franceia, Fragilaria, Gloeothamnion, Haematococcus, Halocafeteria, Hymenomonas, Isochrysis, Lepocinclis, Micractinium, Monoraphidium, Nannochloris, Nannochloropsis, Navicula, Neochloris, Nephrochloris, Nephroselmis, Nitzschia, Ochromonas, Oedogonium, Oocystis, Ostreococcus, Pavlova, Parachlorella, Pascheria, Phaeodactylum, Phagus, Pichochlorum, Pseudoneochloris, Pseudostaurastrum, Platymonas, Pleurochrysis, Pleurococcus, Prototheca, Pseudochlorella, Pyramimonas, Pyrobotrys, Scenedesmus, Schizochlamydella, Skeletonema, Spyrogyra, Stichococcus, Tetrachlorella, Tetraselmis, Thalassiosira, Tribonema, Vaucheria, Viridiella, and Volvox species, and/or one or more cyanobacteria of the Agmenellum, Anabaena, Anabaenopsis, Anacystis, Aphanizomenon, Arthrospira, Asterocapsa, Borzia, Calothrix, Chamaesiphon, Chlorogloeopsis, Chroococcidiopsis, Chroococcus, Crinalium, Cyanobacterium, Cyanobium, Cyanocystis, Cyanospira, Cyanothece, Cylindrospermopsis, Cylindrospermum, Dactylococcopsis, Dermocarpella, Fischerella, Fremyella, Geitleria, Geitlerinema, Gloeobacter, Gloeocapsa, Gloeothece, Halospirulina, lyengariella, Leptolyngbya, Limnothrix, Lyngbya, Microcoleus, Microcystis, Myxosarcina, Nodularia, Nostoc, Nostochopsis, Oscillatoria, Phormidium, Planktothrix, Pleurocapsa, Prochlorococcus, Prochloron, Prochlorothrix, Pseudanabaena, Rivularia, Schizothrix, Scytonema, Spirulina, Stanieria, Starria, Stigonema, Symploca, Synechococcus, Synechocystis, Tolypothrix, Trichodesmium, Tychonema, and Xenococcus species.

The mixtures of the present invention may have broad spectrum algicidal activity. Algae which may be controlled by the method of the present invention include individual species and mixed cultures. Examples of species controlled include, but are not limited to, green algae such as Chlamydomonas reinhardtii, Chlorella pyrenoidosa, Chlorococcum oleofaciens, Anabaena flosaquae, Nostoc commune, and marine algae such as Dunaliella parva.

The amount of the active mixture required to control algae will depend upon many factors such as, for example: the type of surface; the amount of water present; whether the active mixture is incorporated into a coating composition, applied directly to an object, or added to an aqueous or other solution; and the type and extent of algal infestation.

The term “lichen” as used herein refers to a composite organism that arises from algae or cyanobacteria (or both) living among filaments of a fungus in a symbiotic relationship.

The terms “architectural material” or “architectural surface” as used herein refers to, but are not limited to, conventional and non-conventional indoor and outdoor construction and decorative materials, such as wood, sheet-rock (wallboard), paper or vinyl coated wallboard, fabrics (textiles), carpet, leather, ceiling tiles, cellulose resin wall board (fiberboard), stone, brick, concrete, unglazed tile, stucco, grout, painted surfaces, roofing tiles, shingles, and other materials that are cellulose-rich, or are capable of providing nutrients to fungi, or are capable of harboring nutrient materials and supporting a biological infestation. Wood that can be protected by the active compound of the formula (I) or by mixtures containing them is to be understood as meaning, for example, structural timber, wooden beams, railway sleepers, components of bridges, jetties, vehicles made of wood, boxes, pallets, containers, telegraph poles, wooden fences, wooden lagging, windows and doors made of wood, plywood, chipboard, joinery, or wooden products which are used, quite generally, for building houses or in building joinery.

The term “bioactive” as used herein refers to having an effect on a living organism, especially fungal cells. However, in the context of the present disclosure, the term “bioactive composition” refers to a composition that includes both moringa oil and neem oil in amounts that are effective in reducing or preventing the colonization (infestation) of a surface of an object by a fungus, an alga, or a bacterium species. Most advantageously, the bioactive compositions of the disclosure are effective in reducing or preventing the infestation of a surface by a fungus, an alga, or a combination thereof.

The term “antifungal activity” as used herein refers to the inhibition of fungal cell attachment and/or growth, and is may also refer to fungal cell killing. Accordingly, the antifungal compositions of the disclosure can also be denoted as “fungistatic agents” or “fungicides.”

The term “inhibition of fungal growth” as used herein refers to the cessation or reduction of fungal cell proliferation, and can also include inhibition of expression of cellular-produced proteins in static fungal cell colonies. Such inhibition can provide or facilitate disinfection, decontamination or sanitization of inanimate objects, which refer to the process of reducing the number of fungus microorganisms to levels that no longer pose a threat (e.g., to property, human, or animal health).

The term “antialgal activity” as used herein refers to the inhibition of alga cell attachment and/or growth, and is may also refer to algal cell killing. Accordingly, the antifungal compositions of the disclosure can also be denoted as “algistatic agents” or “algicides.”

The term “inhibition of fungal growth” as used herein refers to the cessation or reduction of fungal cell proliferation, and can also include inhibition of expression of cellular-produced proteins in static fungal cell colonies. Such inhibition can provide or facilitate disinfection, decontamination or sanitization of inanimate objects, which refer to the process of reducing the number of fungus microorganisms to levels that no longer pose a threat (e.g., to property, human, or animal health).

The term “inhibition of algal growth” as used herein refers to the cessation or reduction of algal cell proliferation, and can also include inhibition of expression of cellular-produced proteins in static algal cell colonies. Such inhibition can provide or facilitate disinfection, decontamination or sanitization of inanimate objects, which refer to the process of reducing the number of organisms to levels that no longer pose a threat (e.g., to property, human, or animal health).

The term “biocide” as used herein refers to a substance that kills microorganisms and their spores. Depending on the type of microorganism killed, a biocidal substance may be further defined as a bactericide, fungicide, or algaecide. The term “biostatic” refers to a substance that prevents the growth of the microorganism and its spores, and encompasses bacteriostatic, fungistatic and algaestatic compounds.

The term “fungicide” as used herein refers to a biocidal substance used to kill or inactivate a specific microbial group, the fungi. The term “fungistatic,” as used herein refers to a substance that prevents fungal microorganisms from growing or reproducing, but does not result in substantial inactivation or killing.

The term “effective amount” as used herein refers to a concentration of moringa oil or neem oil that is capable of exerting the desired bioactive effect.

The term “base” or “substrate” refers to any surface that can potentially support the infestation and/or growth of a fungus or spore under favorable conditions for such infestation or growth. It is intended to include exterior surfaces of objects as well as interior surfaces of porous and semiporous objects (e.g., high surface area porous stone structures, wood surfaces (both treated and untreated) on which a coating can be directly applied and/or impregnated.

The term “coating” as used herein refers to the process of applying (e.g., brushing, dipping, spreading, spraying) or otherwise producing a coated surface, which may also be referred to as a coating, coat, covering, film or layer on a surface.

Where the context so indicates, the term “coating” may instead refer to the coating composition or mixture that is applied. For example, a coating composition may be capable of undergoing a change from a fluid to a non-fluid condition by removal of solvents, vehicles or carriers, by setting, by chemical reaction or conversion, or by solidification from a molten state. The coating or film that is formed may be hard or soft, elastic or inelastic, permanent or transitory. Where the context allows, the act of coating also includes impregnating a surface or object by causing a coating material to extend or penetrate into the object, or into the interstices of a porous, cellular or foraminous material. The term “coating” (“coat,” “surface coat,” “surface coating”) is also intended to be consistent with its use in “PAINT and Coating Testing Manual” Fourteenth Edition of the Gardner-Sward Handbook (Koleske, J. V. Ed.), p. 696, 1995; and in “ASTM Book of Standards, Volume 06.01, Paint—Tests for Chemical, Physical, and Optical Properties; Appearance,” D16-00, 2002, i.e., “a liquid, liquefiable or mastic composition that is converted to a solid protective, decorative, or functional adherent film after application as a thin layer.” Examples of a coating include a clear coating and a paint.

The term “paint” as used herein refers to any liquid, liquefiable, or mastic composition which, after application to a substrate in a thin layer, is converted to a solid film. It is most commonly used to protect, color or provide texture to objects. Paint contains a binder (also known as a vehicle or resin), a diluent or solvent, a pigment or filler, and may also have other additives. The binder, commonly called the vehicle, is the film-forming component of paint. It is the only component that must be present. Components listed below are included optionally, depending on the desired properties of the cured film.

A binder imparts adhesion and strongly influences such properties as gloss, durability, flexibility, and toughness. In latex paint the binder comprises latex. Latex is a stable dispersion (colloidal emulsion) of polymer microparticles in an aqueous medium. Thus, it is a suspension/dispersion of rubber or plastic polymer microparticles in water. Latexes may be natural or synthetic. Polymerization is a preferred technology used to make emulsion polymers and polymer latexes.

The paint compositions of the disclosure may contain a cross-linkable monomer, such as a “keto”, a carbonyl, or an anhydride group and a cross-linker that will crosslink the “keto”, carbonyl, anhydride groups during and after the paint is dried. Examples of the cross-linkable monomers are methyl vinyl ketone, ethyl vinyl ketone, butyl vinyl ketone (meth)acrolein, crotonaldehyde, diacetone(meth)acrylamide, diacetone (meth)acrylate and mixed esters of aliphatic diols with (meth)acrylic acid and acetoacetic acid, diacetonacrylamide, diacetonemethacrylamide contaiacetoacetoxyethyl methacrylate (AAEM), and diacetone acrylamide (DAAM), maleic anhydride, itaconic anhydride, citraconic anhydride, and the like; examples of a crosslinking agent in the paint composition are hydrazine derivatives, C₂-C₁₈ saturated dicarboxylic acid dihydrazides such as oxalic acid dihydrazide, malonic acid dihydrazide, glutaric acid dihydrazide, succinic acid dihyrazide, adipic acid dihydrazide, sebacic acid dihydrazide and the like; monoolefinic unsaturated dicarboxylic acid dihydrazides such as maleic acid dihydrazide, fumaric acid dihydrazide, itaconic acid dihydrazide and the like; terephtalic acid dihydrazide or isophthalic acid dihydrazide; pyromellitic acid dihydrazide, trihydrazide or tetrahydrazide; nitrilotrihydrazide, citric acid trihydrazide, 1,2,4-benzene trihydrazide, ethylenediaminetetraacetic acid tetrahydrazide, 1,4,5,8-naphthoic acid tetrahydrazide; polyfunctional hydrazides, hydrazines, semicarbazides, and the like.

Latex paints are used for a variety of applications including interior and exterior, and flat, semi-gloss and gloss applications. Latex polymer binder is a latex polymer which coalesces to form a film. Latex paints cure by a process called coalescence where first the water, and then the trace, or coalescing, solvent, evaporate and draw together and soften the latex polymer binder particles and fuse them together into irreversibly bound networked structures, so that the paint will not redissolve in the solvent/water that originally carried it. Such paints or coatings are adversely affected by the presence of emulsifiers required in the emulsion polymerization process. In latex polymerization, surfactants are necessary to provide stable monomer pre-emulsion, stability during the polymerization, and overall stability of the final latex.

Diluents dissolve the polymer and adjust the viscosity of the paint. They are volatile and do not become part of the paint film. They also control flow and application properties, and in some cases can affect the stability of the paint while in liquid state. The main function is as the carrier for the non-volatile components. To spread heavier oils (for example, linseed) as in oil-based interior house paint, a thinner oil is required. These volatile substances impart their properties temporarily; once the solvent has evaporated, the remaining paint is fixed to the surface. This component is optional: some paints have no diluent. Water is the main diluent for water-borne paints, even the co-solvent types. Solvent-borne, also called oil-based, paints can have various combinations of organic solvents as the diluent, including aliphatics, aromatics, alcohols, ketones and white spirit. Specific examples are organic solvents such as petroleum distillate, esters, glycol ethers, and the like. Sometimes volatile low-molecular weight synthetic resins also serve as diluents.

Besides the three main categories of ingredients, paint can have a wide variety of miscellaneous additives, which are usually added in small amounts, yet provide a significant effect on the product. Some examples include additives to modify surface tension, improve flow properties, improve the finished appearance, increase wet edge, improve pigment stability, impart antifreeze properties, control foaming, control skinning, etc. Other types of additives include catalysts, thickeners, stabilizers, emulsifiers, texturizers, adhesion promoters, UV stabilizers, flatteners (de-glossing agents), and the like. Additives normally do not significantly alter the percentages of individual components in a formulation

The paint may contain one or more coalescence aids. Coalescence aids assist the formation of a film during the drying process of the paint. Examples of low-VOC (volatile oxygen content) coalescing agents can include, but are not limited to, fatty acid alkylene glycol monoesters (e.g., those compounds sold under the tradename Archer RC.®., aromatic alkoxylates (e.g., cresol propoxylates such as those compounds sold under the tradename PLURACOAT.®., including PLURACOAT.®. CA120, PLURACOAT.®. CA110, and PLURACOAT.®. CA100), compounds sold under the tradename EDENOL.®. (e.g., EDENOL.®. EFC 100), compounds sold under the tradename OPTIFILM.®. (e.g., OPTIFILM.®. Enhancer 400), and the like, and combinations thereof. While less preferred, the composition can contain traditional (VOC) coalescence aids, which can include, but are not limited to, 2-ethylhexyl ether of ethylene glycol, alkyl esters of aromatic carboxylic acids (e.g., 2-ethylhexyl benzoate, methyl carbitol, propylene glycol, ethylene glycol, optionally-alkyl-substituted alkanediol organic carboxylic acid monoesters (e.g., 2,2,4-trimethyl-1,3-pentanediol monoisobutyrate), phosphate salts such as potassium tetrapyrophosphate, plasticizers such as dibutyl phthalate, and the like, and combinations thereof.

Examples of defoamers useful in the compositions according to the disclosure may include, but are not limited to, polysiloxane-polyether copolymers such as those sold under the tradenames FOAMEX.®., BYK.®., DREWPLUS.®., SURFYNOL.®., and the like, and combinations thereof.

Examples of rheology modifiers useful for incorporation into the compositions of the disclosure include, but are not limited to, those commercially available under the tradenames ACRYSOL.®., such as RM-242, RM-8W, RM-825, RM-5000, RM-2020 NPR and RM-825, NATRASOL.®., AQUAFLOW.®., and UCAR POLYPHOBE.®.

An exemplary paint composition can be formulated according to the following method without limiting the order of the addition of each ingredient. First, a pigment dispersion composition, or grind, is formed by: combining water, an optional organic solvent, a dispersant, a pH adjuster, a surfactant, a defoamer, a pigment/colorant, and moringa oil and neem oil; stirring and optionally grinding for a period of time to sufficiently mix the ingredients; and, while continuing to stir and/or grind, adding more water. To this pigment dispersion composition can be added a polymer monomeric precursor, followed by a pH adjuster, if desired, and an optional performance additive composition, such as without limitation, a surfactant, and a defoamer. A coalescence aid may optionally be added. Then, one or more rheology modifiers may be added, optionally including water, and a pH adjuster, forming the paint composition. Additional pigment/colorants may also be added, if desired for shading.

The term “pigment” as used herein refers to granular solids incorporated in the paint to contribute color and/or to non-granular colorants. Fillers are granular solids incorporate to impart toughness, texture, give the paint special properties, or to reduce the cost of the paint. Alternatively, some paints contain dyes instead of or in combination with pigments. Pigments can be classified as either natural or synthetic types. Natural pigments include various clays, calcium carbonate, mica, silicas, and talcs. Synthetics would include engineered molecules, calcined clays, blanc fixe, precipitated calcium carbonate, and synthetic pyrogenic silicas. Hiding pigments, in making paint opaque, also protect the substrate from the harmful effects of ultraviolet light. Hiding pigments include titanium dioxide, phthalo blue, red iron oxide, and many others. Fillers are a special type of pigment that serves to thicken the film, support its structure and increase the volume of the paint. Fillers are usually cheap and inert materials, such as diatomaceous earth, talc, lime, barytes, clay, etc. Floor paints that will be subjected to abrasion may contain fine quartz sand as filler. Not all paints include fillers. On the other hand, some paints contain large proportions of pigment/filler and binder.

Examples of pigments/colorants useful for incorporation into the compositions of the disclosure include, but are not limited to, titanium oxide, carbon black, iron oxide black, iron oxide yellow, iron oxide red, iron oxide brown, organic red pigments, including quinacridone red and metallized and non-metallized azo reds (e.g., lithols, lithol rubine, toluidine red, naphthol red), phthalocyanine blue, phthalocyanine green, mono- or di-arylide yellow, benzimidazolone yellow, heterocyclic yellow, DAN orange, quinacridone magenta, quinacridone violet, and the like, and any combination thereof. Color pigments can be added as powders, but can more conveniently be added as aqueous dispersions to paint compositions according to the disclosure.

Extender pigments/colorants can be added. Examples of extender pigments/colorants useful for incorporation into the compositions of the disclosure include, but are not limited to, silica, silicates, carbonates such as calcium carbonates, and the like, and combinations thereof.

Pigments may be present in the coating compositions of the disclosure in concentrations from about 1 wt. % to about 50 wt. %; preferably, from about 10 wt. % to about 40 wt. %; more preferably, from about 15 wt. % to about 35 wt. %. Dried and/or cured coatings of the present disclosure may contain pigments in concentrations from about 1 wt. % to about 72 wt. %; preferably, from about 14 wt. % to about 57 wt. %; more preferably, from about 21 wt. % to about 50 wt. %.

Wetting agents are substances that reduce the surface tension of a liquid and cause the liquid to spread across or penetrate more easily the surface of a solid. Exemplary wetting agents are selected from the group consisting of a solution of a salt of unsaturated polyamine amides and lower molecular acid polymers, sodium polyphosphate, aryl or alkyl phosphates, salts of low molecular weight poly(acrylic acid), salts of sulfonated polyethylene, salts of poly (vinyl-phosphonic acid), salts of poly(maleic acid), salts of copolymers of maleic acid with olefins, and combinations thereof. In some embodiments, the dried and/or cured coating and the coating composition can comprise a solution of a salt of unsaturated polyamine amides and lower molecular acid polymers sold by BYK Chemie under the trade name Anti-Terra.®.-U. In addition to its function as a wetting agent Anti-Terra.®.-U acts as a dispersing agent by deflocculating pigments. It stabilizes the pigments through steric interaction and balances the electric charge of pigments.

The term “elastomer” as used herein refers to rubbers that are polymers that can undergo large, but reversible, deformations upon a relatively low physical stress such as tire rubbers, polyurethane elastomers, polymers ending in an anionic diene, segmented polyerethane-urea copolymers, diene triblock polymers with styrene-alpha-methylstyrene copolymer end blocks, poly (p-methylstyrene-b-p-methylstyrene), polydimethylsiloxane-vinyl monomer block polymers, chemically modified natural rubber, polymers from hydrogenated polydienes, polyacrylic elastomers, polybutadienes, trans-polyisoprene, polyisobutene, cis-1,4-polybutadiene, polyolefin thermoplastic elastomers, block polymers, polyester thermoplastic elastomer, thermoplastic polyurethane elastomers) and techniques of elastomer synthesis and elastomer property analysis have been described, for example, in Walker, B. M., ed., Handbook of Thermoplastic Elastomers, Van Nostrand Reinhold Co., New York, 1979; Holden, G., ed., et. al., Thermoplastic Elastomers, 2nd Ed., Hanser Publishers, Verlag, 1996.

The term “adhesive” as used herein refers to a composition that is capable of uniting, bonding or holding at least two surfaces together, preferably in a strong and permanent manner (e.g., glue, cement, paste).

The term “alkyl” as used herein refers to a monovalent straight or branched saturated hydrocarbon radical, more typically, a monovalent straight or branched saturated (C.sub.1-C.sub.40) hydrocarbon radical, such as, for example, methyl, ethyl, n-propyl, isopropyl, n-butyl, isobutyl, tert-butyl, hexyl, octyl, hexadecyl, octadecyl, eicosyl, behenyl, tricontyl, and tertacontyl.

The term “alkoxyl” as used herein refers to an oxy radical that is substituted with an alkyl group, such as for example, methoxyl, ethoxyl, propoxyl, isopropoxyl, or butoxyl, which may optionally be further substituted on one or more of the carbon atoms of the radical.

The term “alkoxyalkyl” as used herein refers to an alkyl radical that is substituted with one or more alkoxy substituents, more typically a (C₁-C₂₂)alkyloxy-(C₁-C₆)alkyl radical, such as methoxymethyl, and ethoxybutyl.

The term “alkenyl” as used herein refers to an unsaturated straight or branched hydrocarbon radical, more typically an unsaturated straight, branched, (C₁-C₂₂) hydrocarbon radical, that contains one or more carbon-carbon double bonds, such as, for example, ethenyl, n-propenyl, iso-propenyl.

The terms “aqueous medium” and “aqueous media” as used herein refer to any liquid medium of which water is a major component. Thus, the term includes water per se as well as aqueous solutions and dispersions.

The term “aryl” as used herein refers to a monovalent unsaturated hydrocarbon radical containing one or more six-membered carbon rings in which the unsaturation may be represented by three conjugated double bonds, which may be substituted one or more of carbons of the ring with hydroxy, alkyl, alkoxyl, alkenyl, halo, haloalkyl, monocyclic aryl, or amino, such as, for example, phenyl, methylphenyl, methoxyphenyl, dimethylphenyl, trimethylphenyl, chlorophenyl, trichloromethylphenyl, triisobutyl phenyl, tristyrylphenyl, and aminophenyl.

The term “aralkyl” as used herein refers to an alkyl group substituted with one or more aryl groups, more typically a (C₁-C₁₈)alkyl substituted with one or more (C₆-C₁₄)aryl substituents, such as, for example, phenylmethyl, phenylethyl, and triphenylmethyl.

The term “aryloxy” as used herein refers to an oxy radical substituted with an aryl group, such as for example, phenyloxy, methylphenyl oxy, isopropylmethylphenyloxy.

The terminology “(Cₓ-C_{y})” in reference to an organic group, wherein x and y are each integers, indicates the group may contain from x carbon atoms to y carbon atoms per group.

The term “cycloalkenyl” as used herein refers to an unsaturated hydrocarbon radical, typically an unsaturated (C₅-C₂₂) hydrocarbon radical, that contains one or more cyclic alkenyl rings and which may optionally be substituted on one or more carbon atoms of the ring with one or two (C₁-C₆)alkyl groups per carbon atom, such as cyclohexenyl, cycloheptenyl, and “bicycloalkenyl” as used herein refers to a cycloalkenyl ring system that comprises two condensed rings, such as bicycloheptenyl.

The term “cycloalkyl” as used herein refers to a saturated hydrocarbon radical, more typically a saturated (C₅-C₂₂) hydrocarbon radical, that includes one or more cyclic alkyl rings, which may optionally be substituted on one or more carbon atoms of the ring with one or two (C₁-C₆)alkyl groups per carbon atom, such as, for example, cyclopentyl, cycloheptyl, cyclooctyl, and “bicyloalkyl” as used herein refers to a cycloalkyl ring system that comprises two condensed rings, such as bicycloheptyl.

The term “heterocyclic” as used herein refers to a saturated or unsaturated organic radical that comprises a ring or condensed ring system, typically comprising from 4 to 16 ring atoms per ring or ring system, wherein such ring atoms comprise carbon atoms and at least one heteroatom, such as for example, O, N, S, or P per ring or ring system, which may optionally be substituted on one or more of the ring atoms, such as, for example, thiophenyl, benzothiophenyl, thianthrenyl, pyranyl, benzofuranyl, xanthenyl, pyrolidinyl, pyrrolyl, pyradinyl, pyrazinyl, pyrimadinyl, pyridazinyl, indolyl, quinonyl, carbazolyl, phenathrolinyl, thiazolyl, oxazolyl, phenoxazinyl, or phosphabenzenyl.

The term “hydroxyalkyl” as used herein refers to an alkyl radical, more typically a (C₁-C₂₂)alkyl radical, that is substituted with one or more hydroxyl groups, such as for example, hydroxymethyl, hydroxyethyl, hydroxypropyl, and hydroxydecyl.

As used herein, the indication that a radical may be “optionally substituted” or “optionally further substituted” as used herein refers to, in general, that is unless further limited, either explicitly or by the context of such reference, that such radical may be substituted with one or more inorganic or organic substituent groups, such as, for example, alkyl, alkenyl, aryl, aralkyl, alkaryl, a hetero atom, or heterocyclyl, or with one or more functional groups that are capable of coordinating to metal ions, such as hydroxyl, carbonyl, carboxyl, amino, imino, amido, phosphonic acid, sulfonic acid, or arsenate, or inorganic and organic esters thereof, such as, for example, sulfate or phosphate, or salts thereof.

The term “sealant” as used herein refers to a composition capable of attaching to at least two surfaces, filling the space between them to provide a barrier or protective coating (e.g., by filling gaps or making a surface nonporous).

The term “glycol ether” as used herein refers to methyl glycol, ethyl glycol, propyl glycol, isopropyl glycol, butyl glycol, methyl diglycol, ethyl diglycol, butyl diglycol, ethyl triglycol, butyl triglycol, diethylene glycol dimethyl ether, methoxypropanol, isobutoxypropanol, isobutyl glycol, propylene glycol monoethyl ether, 1-isopropoxy-2-propanol, propylene glycol mono-n-propyl ether, propylene glycol n-butyl ether, methyl dipropylene glycol, methoxybutanol, or a combination thereof.

The term “ketone” as used herein refers to acetone, methyl ethyl ketone, methyl propyl ketone, methyl isopropyl ketone, methyl butyl ketone, methyl isobutyl ketone, methyl amyl ketone, methyl isoamyl ketone, diethyl ketone, ethyl amyl ketone, dipropyl ketone, diisopropyl ketone, cyclohexanone, methylcylcohexanone, trimethylcyclohexanone, mesityl oxide, diisobutyl ketone, isophorone.

The term “resin” as used herein refers to, but is not limited to, polysulfonates, silyl ether polymers, and polyphosphates, polyethyl resins, epoxy resins and the like.

The term “pigment” as used herein refers to, but is not limited to, calcium carbonate, zinc oxide, iron oxide, and color pigments.

The term “solvent” as used herein refers to, but is not limited to, xylene, methyl iso-butyl ketone, other organic solvents including, but not limited to, acetone, turpentine and synthetic paint solvent. An acrylic based paint or medium may have as a solvent an aqueous based medium that may comprise other solvents including, for example, isopropanol.

The terms “binder” as used herein refers to, but is not limited to, rosins, resins, acrylic siloxine, acrylic-siloxine graft copolymers, calcium carbonate, siloxanes, silicones, silylacrylates, hydrolysable; trimethylsilyloxyethyl methacrylate copolymer; the copolymers methyl acrylate, methyl methacrylate, styrene, lauryl methacrylate, vinyl acetate, vinyl chloride, acrylate copolymer paint binders and ester terminated silicones.

The term “anti-settling agent” as used herein refers to, but is not limited to, polyamide wax, paraffin waxes and hydrocarbon waxes.

The term “antimicrobial effective amount” as used herein refers to the amount of antimicrobial ingredient, that as a whole, provides an antimicrobial (including, for example, biocide, mildewcide, antiviral, antibacterial, antialgal, or antifungal) activity that reduces, prevents, or eliminates one or more species of microbes, such that an acceptable level of the microbe results.

The term “architectural coating” as used herein is intended to encompass a mixture of resin, optionally pigment, and a suitable liquid vehicle that is reasonably fluid and provides a thin and adherent layer when applied to a substrate. As such, the term “architectural coating” is intended to encompass paints, lacquers, varnishes, base coats, clear coats, primers and the like.

The term “surfactant” as used herein refers to a compound that reduces surface tension when dissolved in water. Surfactants can be classified according to the nature of the charge on individual polar moiety. Anionic surfactants are negatively charged usually due to a sulfonate or sulfur group. Non-ionic surfactants lack ionic constituent and the majority of all nonionics are polymerization products of 1,2-epoxyethane. Cationic surfactants are characterized by a quaternary ammonium group which is positively charged. Lastly, amphoteric surfactants have both positively and negatively charged moieties in the same molecule. Biosurfactants can also be grouped into two categories namely, (1) low-molecular-mass molecules with lower surface and interfacial tensions and (2) high-molecular-mass polymers which bind tightly to surfaces. Examples of low-molecular-mass molecules are rhamnolipids and sophorolipids. Examples of high molecular-mass polymers are food emulsifiers and biodispersants.

Non-ionic and/or anionic surfactants include, but are not limited to, such as ammonium nonoxynol-4 sulfate, nonylphenol (10) ethoxylate, nonylphenol (about.10 mol %) ethoxylate, nonylphenol (about.40 mol %) ethoxylate, octylphenol (about.40 mol %) ethoxylate, octylphenol (9-10) ethoxylate, sodium dodecyl sulfonate, sodium tetradecyl sulfonate, sodium hexadecyl sulfonate, polyether phosphate esters, alcohol ethoxylate phosphate esters, compounds sold under the tradename Triton.®. (e.g., QS series, CF series, X series, and the like), compounds sold under the tradename Rhodapon.®., compounds sold under the tradename Rhodapex.®., compounds sold under the tradename Rhodacal.®., compounds sold under the tradename Rhodafac.®., and the like, and combinations thereof.

### Description

It has been found that a combination of the oils extracted from the seeds of the Moringa and Neem trees is effective in inhibiting or preventing infestations and proliferation of fungi that can thrive under wet, damp, or humid conditions on exposed surfaces. It has been found that combining the two oils and applying the oils to a surface susceptible to biological infestations or growths such as a fungal species, an algal species, or a combination thereof affords greater protection efficiency than if either of the oils is used in isolation. The present disclosure, therefore, encompasses embodiments of coating formulations containing moringa and neem oils that may be mixed with a base paint or other coating, which may be any suitable commercially available product, a wide variety of which are well known in the art, and used as extended-period inhibitors of biological infestations.

The moringa oil-neem oil compositions of the disclosure are also effective against other infestations, including but not limited to algae and lichens that may grow on or in a medium and which thereby may lead to destruction of the integrity of the medium or produce unsightly and undesired visual contamination.

It is within the scope of the disclosure for the two oils, moringa oil and neem oil, to be simultaneously applied to a surface to be treated by combining the oils together in a vehicle. In the alternative, it is further considered to be within the scope of the disclosure for the oils to be applied to a surface to be treated by superimposing layers of vehicles, wherein the superimposed layers independently comprise one or other of the oils, or both of the oils. When so applied, the superimposed layers either comingle in whole or in part before loss of any volatile solvent (drying) or polymerization of the vehicle of the layers, or remain as distinct superimposed layers, the component oils then cooperating to synergistically inhibit a biological infestation development.

The novel combination of the moringa oil and neem oil of the disclosure are suitable for combination with not only liquid vehicles but also with semi-solid or solid vehicles (in the latter case typically forming a semi-solid of malleable paste). These embodiments of the compositions of the disclosure are advantageous for using as a tile grout, spreadable wall coating and the like for application in situations that are conducive to the formation of an undesirable biological infestation. For example, a grouting composition according to the disclosure is especially advantageous for use in bathrooms that are frequently exposed to wet or humid conditions and hence subject to molds such as mildew. Accordingly, the moringa oil-neem oil combination of the disclosure can be admixed with such as a cement-based or polymer-based grouting or sealant compound or the like.

The compositions of the disclosure may further include vehicles suitable for use as adhesives. Organic-based adhesives, even when applied to two opposing surfaces, and therefore only minimally exposed to the surrounding atmosphere, are still susceptible to biological infestations extending from the surfaces of the adhesive not in contact with the opposing surfaces, or even from within the adhesive layer. Accordingly, for such applications, the vehicle combined with the moringa and neem oils can be any adhesive known in the art that is, preferably, not substantially weakened by the admixing of the moringa and neem oils.

The polymeric compositions comprising moringa oil and neem oil further include polymeric materials used as seals as applied to a refrigerator or freezer door. Such seals are exposed to humid conditions resulting from condensation due the polymer seal having a temperature that is below the atmospheric dew point. Extended exposure to such moisture can allow fungi, mildew and the like to form, resulting in unsightly and unhygienic infestations. By incorporating the moringa oil and the neem oil in the polymeric base, such infestations may be reduced or eliminated, reducing the necessity for frequent cleaning and avoiding the risk of contamination of foods or exposure of humans and pets to toxic allergens.

The polymeric compositions comprising moringa oil and neem oil according to the disclosure may also be advantageously incorporated into any item that may be exposed to environmental conditions that can support a fungal, algal, or bacterial infestation. For example, but not intended to be limiting, an elastomeric polymer that includes the moringa oil-neem oil combination may be used as a tape or flexible sheet for sealing of such as the connecting joints of an air-conditioning duct. Where such tapes or sheets further comprise an adhesive layer, the polymer of the adhesive may also comprise the moringa oil-neem oil combination.

Preferably the base vehicle composition is free of chemicals and other additives that are toxic to humans or animals, and/or that fail to comply with applicable environmental safety rules or guidelines. In some instances, it may be preferred to custom blend a paint or coating mixture using any combination of various naturally-occurring and synthetic components and additives that are known in the art.

Compositions comprising moringa and neem oils may be formulated as coating components and generally include a binder, a liquid component such as, but not limited to, a solvent, and optionally a colorizing agent, one or more additives, or a combination of any of those. A coating typically comprises a material often referred to as a “binder,” which is the primary material in a coating capable of producing a film. Generally, a coating will comprise a liquid component (e.g., a solvent, a diluent, a thinner), which often confers and/or alters the coating's rheological properties (e.g., viscosity) to ease the application of the coating to a surface. A coating (e.g., a paint) can include a colorizing agent (e.g., a pigment), which usually functions to alter an optical property of a coating and/or film. A coating will often comprise an additive, which is a composition incorporated into a coating to (a) reduce and/or prevent the development of a physical, chemical, and/or aesthetic defect in the coating and/or film; (b) confer some additional desired property to a coating and/or film; or (c) a combination thereof. Examples of an additive include an accelerator, an adhesion promoter, an antifloating agent, an antiflooding agent, an antifoaming agent, an antioxidant, an antiskinning agent, a buffer, a catalyst, a coalescing agent, a corrosion inhibitor, a defoamer, a dehydrator, a dispersant, a drier, an electrical additive, an emulsifier, a film-formation promoter, a fire retardant, a flow control agent, a gloss aid, a leveling agent, a light stabilizer, a marproofing agent, a matting agent, a neutralizing agent, a preservative, a rheology modifier, a slip agent, a viscosity control agent, a wetting agent, or a combination thereof. The content for an individual coating additive in a coating generally is 0.0001% to 20.0%, including all intermediate ranges and combinations thereof. However, in many instances it is preferred if the concentration of a single additive in a coating comprises between 0.1% and 30.0%, including all intermediate ranges and combinations thereof.

It is further considered advantageous to add the moringa and neem oils together to compositions under storage before applying the compositions to a surface to be treated to prevent a biological infestation.

A preservative may comprise an in-can preservative, an in-film (coating) preservative, or a combination thereof. An in-can preservative is a composition that reduces or prevents the growth of a microorganism prior to film formation. Addition of an in-can preservative during a water-borne coating production typically occurs with the introduction of water to a coating composition. Typically, an in-can preservative is added to a coating composition for function during coating preparation, storage, or a combination thereof. An in-film preservative is a composition that reduces or prevents the growth of a microorganism after film formation. Often times an in-film preservative is the same chemical as an in-can preservative, but added to a coating composition at a higher (e.g., at least a two-fold) concentration for continuing activity after film formation.

The moringa oil-neem oil compositions of the disclosure may be formulated in a latex base, such as presented in Examples 1-6, and which are especially advantageous for impregnating the interstitial spaces of a multifiber material or porous surface. When set, the latex polymer base can provide a durable and flexible coating incorporating the anti-biological infestation bioactive oil mixture compositions of the disclosure. The compositions may be applied to a surface by any method known to one of skill in the art and adapted for the material to be coated. For example the surfaces or equipment may be coated by dipping, spraying, brush painting, or immersion in the bioactive polymer composition.

An advantageous synthetic polymer composition, as described in Examples 1-6 may comprise a polyurethane based thickener, at least one surfactant, at least one latex acrylic, a curing accelerator, and a cross-linker. For example, one advantageous composition of the latex polymer base comprises the surfactant COATOSIL.® 1211, the surfactant/wetting agent SILWET.® L-77, the latex acrylic NOVACRYL.®-DP-126, the latex acrylic ACRYGEN.® 8662, cure accelerator ANCAMINE.® K-54, and the silicone/epoxy cross-linker COATOSIL.® 1770. Of the acrylic latexes, NOVACRYL.®-DP-126 is a soft adhesive grade (20% of base polymers) and N- 8662 is less tacky, tougher (80% of base polymers)—the weight-to-weight ratio of these two components may range from about 10:90 to about 60:10. Of the surfactants, C-1211 & L-77 add chemical and mechanical stability to the latex base and to the final antifouling composition, and reinforces the emulsification of the antifouling agents. Cross-linking of the acrylic latexes in this example is accomplished by using ANCAMINE.® K-54 & COATOSIL.® 1770 that effect cross-linking of the base polymers.

Optionally, in the latex base formulations for use in the present disclosure, ACRYSOL.® RM-825 is included when the mixture is dilute, i.e. 25% (for better stability & shelf life); at higher percentage solids of the moringa and neem oil combination, i.e. 40-49%, less ACRYSOL.® RM-825 may be included to avoid excessive thickening; and may range from about 0.01% to about 5.0 weight percent of the dry latex solids.

It is within the scope of the disclosure, therefore, that the moringa and neem oil combination of the disclosure may be incorporated into any polymer base that is suitable for coating or manufacturing an object or surface that may be exposed to an aqueous, humid, damp or wet environment.

Microorganisms which may be inhibited by the biocidal (bioactive) moringa oil-neem oil combination of the present disclosure include, but are not limited to: Fungi, such as Aspergillus flavus, A. fumigalus, A. niger, Blastomyces dermatitidis, Candida spp., Coccidioides immitis, Cryptococcus neoformans, Fusarium culmorum, Geotrichum spp., Histoplasma capsulatum, Malassezia furfur, Microsporum spp., Mucor racemosus, Nocardia spp., Paracoccidioides brasiliensis, Penicillium spp., Rhizopus higricans, Saccharomyces cerevisiae, Sporothrix schneckii, Torulopsis spp., Trichophyton spp, Bacteria, such as Aerobacter aerongenes, Aeromonas hydrophila, Bacillus cereus, Bacillus subtilis, Bordetella pertussis, Borrelia burgdorferi, Campylobacter fetus, C. jejuni, Corynebacterium diphtheriae, C. bovis, Desulfovibrio desulfurica, Escherichia coli 0157:H7, Enteropathogenic E. coli, Enterotoxin-producing E. coli, Helicobacter pylori, Klebsiella pneumoniae, Legionella pneumophila, Leptospira interrogans, Mycobacterium tuberculosis, M. bovis, Neisseria gonorrhoeae, N. meningitidis, Proteus mirabilis, P. vulgaris, Pseudomonas aeruginosa, Rhodococcus equi, Salmonella choleraesuis, S. enteridis, S. typhimurlum, S. typhosa, Shigella sonnei, S. dysenteriae, Staphylococcus aureus, S. epidermidis, Streptococcus anginosus, S. mutans, Vibrio cholerae, Yersinia pestis, Y. pseudotuberculosis, Actinomycetes, Stretomyces reubrireticuli, Streptoverticillium reticulum, Thermoactinomyces vulgaris.

The amounts of the bioactive moringa oil and neem oil added to the compositions of the disclosure may be adjusted according to a particular application. Factors to consider are the conditions under which the composition is to be used, the microorganisms to be inhibited and the duration of the use. It is also advantageous for the concentrations of the moringa oil and neem oil in the compositions of the disclosure not to substantially weaken the integrity of the applied polymeric film such as a paint, a filler, a grout a sealant, and the like. Accordingly, in the compositions of the disclosure the moringa oil and the neem oil may have a combined concentration of from between about 0.001% to about 30% by weight of the composition before application to a surface to be treated, from between about 0.001% to about 30% by weight, from between about 0.001% to about 30% by weight, from between about 0.5% to about 25% by weight , from between about 0.5% to about 20% by weight, from between about 1% to about 15% by weight , from between about 1% to about 10% by weight, from between about 5% to about 10% by weight. Accordingly the concentration of the moringa or neem oils may individually be, but are not limited to, 1%, 5%, 10%, 15%, 20%, 25%, 30% by weight, or any integer or fractional percentage from 0.001% to about 30%. Indeed, any integer or fractional percent weight from 0.001% to about 30% may be useful in describing the present disclosure, such as 0.001%, 0.0015%, 0.1%, 0.15%, 0.2%, 0.25%, 1.1%, 1.2%, 1.5%, 1.7%, 2%, 3%, 4%, 5%, 6%, 7%, 8%, 9%, 10%, 11%, 12%, 13%, 14%, 15%, 20%, 21%, 22%, 23%, 24%, 25%, 26%, 27%, 28%, 29%, 30%, and the like.

Within these ranges of concentrations of the oils, the ratio of moringa oil to neem oil (by weight) may be from between about 10:1 to about 1:10, from between about 5:1 to about 1:5, from between about 2:1 to about 1:2, to about 1:1.

While most preferably, both of the oils may be added together to the same volume of the vehicle, it is also within the scope of the disclosure for the two oils to be independently in separate volumes of the same vehicle or independently in separate volumes of different vehicles. In these embodiment, the two oils may form the compositions of the present disclosure by being applied to a surface to be treated as superimposed layers, whereupon the composition is a multilayered coating.

When making any of the compositions of the present disclosure the moringa oil, the neem oil and any additives may be added to the base vehicle either together or sequentially. The mixture can then mixed until the two oils are evenly dispersed within the polymer coatings before processing of the polymer coating. The applications of the finished product may be compression molded, form molded, sprayed, brushed or extruded.
Method of Impregnating a Porous Substrate to Inhibit Fungus Growth: Porous or semi-porous objects or materials such as wood, paper, fabrics, carpet, some types of stone, and many other items that are employed indoors or outdoors, have internal surface areas that can be susceptible to infestation by mold and are very difficult to treat effectively by conventional methods. It is within the scope of the present disclosure to impregnate such porous objects with a coating material containing moringa oil and neem oil, as described in the present disclosure. The liquidity of the composition is desired to be such that it is capable of penetrating into the pores of the object. In this way, an effective amount of the bioactive moringa oil-neem oil composition is deposited on the internal surfaces as well as the exterior ones. Circumstances requiring treatment of a porous surface may benefit from using a relatively thin coating material rather than a thick, pigmented paint, in order to facilitate penetration of the pores.
Adhesives, sealants and elastomers containing bioactive agents active against a biological infestation: The moringa and neem oil additives described above are expected to be additionally useful for coating or mixing into sealants and elastomers such as grouts and caulks, especially those that are in frequent contact with, or constantly exposed to fungal nutrients and/or moisture. Examples of adhesives and sealants (e.g., caulks, acrylics, elastomers, phenolic resin, epoxy, polyurethane, anaerobic and structural acrylic, high-temperature polymers, water-based industrial type adhesives, water-based paper and packaging adhesives, water-based coatings, hot melt adhesives, hot melt coatings for paper and plastic, epoxy adhesives, plastisol compounds, construction adhesives, flocking adhesives, industrial adhesives, general purpose adhesives, pressure sensitive adhesives, sealants, mastics, urethanes) for various surfaces (e.g., metal, plastic, textile, paper), and techniques of preparation and assays for properties, have been described in Skeist, I., ed., Handbook of Adhesives, 3rd Ed., Van Nostrand Reinhold, New York, 1990; Satriana, M. J. Hot Melt Adhesives: Manufacture and Applications, Noyes Data Corporation, New Jersey, 1974; Petrie, E. M., Handbook of Adhesives and Sealants, McGraw-Hill, New York, 2000; Hartshorn, S. R., ed., Structural Adhesives-Chemistry and Technology. Plenum Press, New York, 1986; Flick, E. W., Adhesive and Sealant Compound Formulations, 2nd Ed., Noyes Publications, New Jersey, 1984; Flick, E., Handbook of Raw Adhesives 2nd Ed., Noyes Publications, New Jersey, 1989; Flick, E., Handbook of Raw Adhesives, Noyes Publications, New Jersey, 1982; Dunning, H. R., Pressure Sensitive Adhesives-Formulations and Technology, 2nd Ed., Noyes Data Corporation, New Jersey, 1977; and Flick, E. W., Construction and Structural Adhesives and Sealants, Noyes Publications, New Jersey, 1988. Kit for preparing an antifungal coating: For ease of production, in most instances a paint or coating product containing bioactive moringa oil and neem oil according to the disclosure can be provided as a single premixed formulation or as separate formulations that be mixed before application to a surface or applied as superimposed layers. Alternatively, in order to optimize the initial activity and extend the useful lifetime of the bioactive coating, the moringa and neem oils may instead be packaged separately from the paint or coating product into which the bioactive agent is to be added.

In some situations it may also be preferred to store a biological infestation-prone material in a separate container (“pot”) prior to application, in order to minimize the occurrence of contamination prior to use and for other reasons. Separation of conventional coating components is typically done to reduce film formation during storage for certain types of coatings. Accordingly, some or all of the different components of the moringa oil-neem oil containing compositions are stored in a plurality of containers, or as a multi-pack kit, and the components are admixed prior to and/or during application. For example, 0.001% to 100%, including all intermediate ranges and combinations thereof, of the bioactive agents of the compositions of the disclosure may be stored in a separate container from one or more biological infestation prone materials of the final composition. A multi-pack kit may include one or more pots of a biological infestation-prone material. A new anti-biological infestation composition may be prepared at or near the time of use by combining a biological infestation -prone material (e.g., carbon polymer-containing binder) with the other coating components, i.e. the moringa and neem oils, as described herein.

One aspect of the disclosure, therefore, encompasses embodiments of a bioactive composition comprising moringa oil and neem oil in a liquid or non-liquid in an amount sufficient to inhibit or prevent a biological infestation or growth on a surface coated with said bioactive composition, wherein the biological infestation or growth comprises a fungal species, an algal species, a bacterial species, or any combination thereof.

In some embodiments of this aspect of the disclosure, each of the moringa oil and the neem oil may independently comprise between about 0.001% to about 30.0% by weight, of the composition.

In some embodiments of this aspect of the disclosure, the moringa oil and the neem oil may be in a ratio of: between about 10:1 to about 1:10 by weight, between about 5:1 to about 1:5 by weight; or between about 2:1 to about 1:2 by weight.

In some embodiments of this aspect of the disclosure, moringa oil and the neem oil may in a ratio of about 1:1 by weight.

In some embodiments of this aspect of the disclosure, the composition may be a coating of a surface of an inanimate object.

In some embodiments of this aspect of the disclosure, the liquid or non-liquid vehicle may comprise a polymer in an amount effective to form the coating when the composition is applied to the surface.

In some embodiments of this aspect of the disclosure, the liquid or non-liquid vehicle may be a paint.

In some embodiments of this aspect of the disclosure, composition may further comprise at least one of a binder in an amount effective to enhance adherence of the coat formed from the composition and a pigment or dye component in an amount effective to impart a color to the coat.

In some embodiments of this aspect of the disclosure, the at least one liquid vehicle may be selected from the group consisting of an organic solvent, a thinner, a diluent, a plasticizer, and water, and wherein, when the vehicle includes water, the composition may further comprise at least one surfactant.

In some embodiments of this aspect of the disclosure, the composition may further comprise at least one of a wetting agent, a buffer, a rheology modifier, a defoamer, a catalyst, an anti-skinning agent, a light stabilizer, a corrosion inhibitor, a dehydrator, an electrical agent, and an anti-insect agent.

In some embodiments of this aspect of the disclosure, the coating may be at least one of a paint and a clear coating, and wherein each of the paint and the clear coating may independently comprise a lacquer, a varnish, a shellac, a stain, a water repellent coating, or a combination thereof.

In some embodiments of this aspect of the disclosure, the non-liquid vehicle may be an adhesive, a grouting mix, a solid or semi-solid polymer, an elastomeric polymer, an organic solid, or an inorganic solid.

In some embodiments of this aspect of the disclosure, the non-liquid vehicle may be an elastomeric polymer configured as a seal for a refrigerator door.

In some embodiments of this aspect of the disclosure, the non-liquid vehicle can be a flexible tape or sheet and optionally further comprising an adhesive layer, wherein the flexible sheet or tape and the optional adhesive can each independently comprise an elastomeric polymer comprising moringa oil and neem oil in amounts sufficient to inhibit or prevent a biological infestation on at least one of a surface of the flexible tape or sheet, the adhesive layer, or within the adhesive layer.

In some embodiments of this aspect of the disclosure, the coating may be a multi-coat system comprising a plurality of superimposed layers, wherein each layer independently comprises moringa oil, neem oil, or a mixture of moringa oil and neem oil.

In some embodiments of this aspect of the disclosure, the coating may be an architectural coating.

In some embodiments of this aspect of the disclosure, the architectural coating may comprise a wood coating, a masonry coating, an artist's coating, a grouting mix, or a combination thereof.

In some embodiments of this aspect of the disclosure, the binder may comprise an oil, an alkyd, an oleoresinous binder, a fatty acid epoxide ester, a polyester binder, an urethane binder, a phenolic resin, an epoxy resin, a polyhydroxyether binder, an acrylic resin, a polyvinyl binder, a rubber resin, a bituminous binder, a polysulfide binder, a silicone binder, or a combination thereof.

In some embodiments of this aspect of the disclosure, the coating may comprise a polyol, an amine, an epoxide, a silicone, a vinyl, a phenolic, a triacrylate, an alkyd resin, an amino resin, a blown oil, an epoxy resin, a polyamide, a polyvinyl resin, an amino resin a phenolic resin, a polyamide, a ketimine, an aliphatic amine, a cycloaliphatic epoxy binder, a polyol, an epoxide, a polyurethane comprising an isocyanate moiety, an alkyd, an urethane, or a combination thereof.

In some embodiments of this aspect of the disclosure, the solvent may comprise at least one of a hydrocarbon, an oxygenated compound, a chlorinated hydrocarbon, a nitrated hydrocarbon, wherein the hydrocarbon may be an aliphatic hydrocarbon, a cycloaliphatic hydrocarbon, a terpene, an aromatic hydrocarbon, or a combination thereof, the aliphatic hydrocarbon may be at least one of a petroleum ether, pentane, hexane, heptane, isododecane, a kerosene, a mineral spirit, a VMP naphthas, the cycloaliphatic hydrocarbon may be at least one of cyclohexane, methylcyclohexane, ethylcyclohexane, tetrahydronaphthalene, decahydronaphthalene, the terpene may be at least one of wood terpentine oil, pine oil, a-pinene, 3-pinene, dipentene, D-limonene, the aromatic hydrocarbon may be at least one of benzene, toluene, ethylbenzene, xylene, cumene, a type I high flash aromatic naphtha, a type II high flash aromatic naphtha, mesitylene, pseudocumene, cymol, styrene, the oxygenated compound is an alcohol, an ester, a glycol ether, a ketone, an ether, and the alcohol may be at least one of methanol, ethanol, propanol, isopropanol, 1-butanol, isobutanol, 2-butanol, tert-butanol, amyl alcohol, isoamyl alcohol, hexanol, methylisobutylcarbinol, 2-ethylbutanol, isooctyl alcohol, 2-ethylhexanol, isodecanol, cylcohexanol, methylcyclohexanol, trimethylcyclohexanol, benzyl alcohol, methylbenzyl alcohol, furfuryl alcohol, tetrahydrofurfuryl alcohol, diacetone alcohol, trimethylcyclohexanol.

Another aspect of the disclosure encompasses embodiments of a method of providing or enhancing resistance to a biological infestation or growth on a surface of an inanimate object, wherein the biological infestation or growth may comprise a fungal species, an algal species, a bacterial species, or any combination thereof, said method comprising applying a coating on the surface of the inanimate object, wherein the coating may comprise a film or liquid coating comprising moringa oil and neem oil, wherein each of the moringa oil and the neem oil are in amounts that synergistically inhibit the biological infestation or growth of the coated surface.

In the embodiments of this aspect of the disclosure, the composition can be a bioactive composition comprising moringa oil and neem oil in a liquid or non-liquid vehicle in an amount sufficient to inhibit or prevent the biological infestation or growth on a surface coated with the bioactive composition.

In some embodiments of this aspect of the disclosure, the coating may comprise a plurality of superimposed layers, each layer independently comprising a liquid or solid vehicle and moringa oil or neem oil.

In some embodiments of this aspect of the disclosure, the method may further comprise adding moringa oil and neem oil to at least one volume of a solid or liquid vehicle, wherein the amount of each oil is effective in reducing the biological infestation or growth on the surface.

In some embodiments of this aspect of the disclosure, the inanimate object may be at least partially porous, the method comprising impregnating at least a portion of said object with the composition comprising moringa oil and neem oil.

In some embodiments of this aspect of the disclosure, the object may comprise at least one porous, semi-porous or non-porous material chosen from the group consisting of wall board, ceiling tile, paper, fabric, concrete, stone, brick, wood, plastic, ceramic, and leather.

Still another aspect of the disclosure encompasses embodiments of a fungus-resistant or bacterium-resistant coated surface of an inanimate object, wherein said surface is resistant to a biological infestation or growth thereon and comprising a film or coating formed from a bioactive composition comprising moringa oil and neem oil in a liquid or non-liquid vehicle in an amount sufficient to inhibit or prevent the biological infestation or growth.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt% to about 5 wt%, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20 ° C. and 1 atmosphere.

### EXAMPLES

### Example 1

TABLE 1
Polymer Base No. 1-(No water; No Acrysol)

| | Dry | Percent Dry | Wet | Percent Wet |
|---|---|---|---|---|
| | Weight | Weight^{a} | weight | Weight^{b} |
| COMPONENT | (g) | (gm/100 g solid) | (g) | (g/100 g solution) |
| CoatOsil 1211 | 0.80 | 4.3 | 0.80 | 2.2 |
| Silwet L-77 | 0.30 | 1.6 | 0.30 | 0.85 |
| Novacryl | 3.10 | 16.6 | 5.13 | 14.6 |
| DP-126 | | | | |
| (60.3% solid) | | | | |
| Acrygen 8662 | 12.38 | 66.5 | 27.52 | 85.6 |
| (45% solid) | | | | |
| Ancamine | 0.34 | 1.8 | 0.34 | 0.97 |
| K-54 | | | | |
| CoatOsil 1770 | 1.05 | 5.6 | 1.05 | 3.0 |
| TOTAL | 17.97 | | 38.76 | |

^{a}Percent Dry Weight calculated before adding water
^{b}Percent Wet Weight calculated after adding water

### Example 2

TABLE 2
Polymer Base No. 2-(Water; No Acrysol)

| | Dry | Percent Dry | Wet | Percent Wet |
|---|---|---|---|---|
| | Weight | Weight^{a} | weight | Weight^{b} |
| COMPONENT | (g) | (g/100 g solid) | (g) | (g/100 g solution) |
| Deionized Water | | | 95.18 | 73.00 |
| CoatOsil 1211 | 0.80 | 4.3 | 0.80 | 0.61 |
| Silwet L-77 | 0.30 | 1.6 | 0.30 | 0.23 |
| Novacryl DP-126 | 3.10 | 16.6 | 5.13 | 3.94 |
| (60.3% solid) | | | | |
| Acrygen 8662 | 12.38 | 66.5 | 27.52 | 21.12 |
| (45% solid) | | | | |
| Ancamine K-54 | 0.34 | 1.8 | 0.34 | 0.26 |
| CoatOsil 1770 | 1.05 | 5.6 | 1.05 | 0.81 |
| TOTAL | 17.97 | | 130.32 | |

### Example 3

TABLE 3
Polymer Base No. 3-(No Water; Acrysol)

| | Dry | Percent Dry | Wet | Percent |
|---|---|---|---|---|
| | Weight | Weight^{a} | weight | Wet Weight^{b} |
| COMPONENT | (g) | (g/100 g solid) | (g) | (g/100 g solution) |
| Acrysol RM-825 | 0.74 | 3.11 | 2.64 | 7.0 |
| (28% soild) | | | | |
| CoatOsil 1211 | 0.80 | 2.69 | 0.80 | 2.11 |
| Silwet L-77 | 0.30 | 1.26 | 0.30 | 0.8 |
| Novacryl DP-126 | 3.10 | 13.05 | 5.13 | 13.6 |
| (60.3% solid) | | | | |
| Acrygen 8662 | 12.38 | 52.11 | 27.52 | 72.84 |
| Ancamine K-54 | 0.34 | 1.43 | 0.34 | 0.9 |
| CoatOsil 1770 | 1.05 | 4.42 | 1.05 | 2.78 |
| TOTAL | 18.63 | | 37.78 | |

The thickness protective colloid (Acrysol RM-825) is added for increased stability and longer shelf life of the liquid mixture. RM-825 is a polyurethane based thickener.

### Example 4

TABLE 4
Polymer Base No. 4-(Water; Acrysol)

| | Dry | Percent Dry | Wet | Percent Wet |
|---|---|---|---|---|
| | Weight | Weight^{a} | weight | Weight^{b} |
| COMPONENT | (g) | (g/100 g solid) | (g) | (g/100 g solution) |
| Deionized Water | | | 95.18 | 71.59 |
| Acrysol RM-825 | 0.74 | 3.11 | 2.64 | 1.99 |
| CoatOsil 1211 | 0.80 | 2.69 | 0.80 | 0.6 |
| Silwet L-77 | 0.30 | 1.26 | 0.30 | 0.23 |
| Novacryl DP-126 | 3.10 | 13.05 | 5.13 | 3.86 |
| (60.3% wet | | | | |
| weight) | | | | |
| Acrygen 8662 | 12.38 | 52.11 | 27.52 | 20.7 |
| Ancamine K-54 | 0.34 | 1.43 | 0.34 | 0.26 |
| CoatOsil 1770 | 1.05 | 4.42 | 1.05 | 0.79 |
| TOTAL | 18.63 | | 132.96 | |

### Example 5

TABLE 5
Polymer Base No. 5-(No water; Acrysol;
Diethyleneglycolbutylether)

| | Dry | Percent Dry | Wet | Percent Wet |
|---|---|---|---|---|
| | Weight | Weight^{a} | weight | Weight^{b} |
| COMPONENT | (g) | (g/100 g solid) | (g) | (g/100 g solution) |
| Acrysol RM-825 | 0.74 | 3.11 | 2.64 | 6.18 |
| CoatOsil 1211 | 0.80 | 2.69 | 0.80 | 1.87 |
| Silwet L-77 | 0.30 | 1.26 | 0.30 | 0.7 |
| Novacryl DP-126 | 3.10 | 13.05 | 5.13 | 12.01 |
| (60.3% wet | | | | |
| weight) | | | | |
| Acrygen 8662 | 12.38 | 52.11 | 27.52 | 64.42 |
| Ancamine K-54 | 0.34 | 1.43 | 0.34 | 0.8 |
| CoatOsil 1770 | 1.05 | 4.42 | 1.05 | 2.46 |
| Diethylene- | 5.00 | 21.05 | 5.00 | 11.7 |
| glycolbutylet | | | | |
| TOTAL | 23.71 | | 42.78 | |

### Example 6

TABLE 8
Polymer base No. 6-(Water; Acrysol; Diethyleneglycolbutylether)

| | Dry | Percent | Wet | Percent |
|---|---|---|---|---|
| | Weight | Dry Weight^{a} | weight | Wet Weight^{b} |
| COMPONENT | (g) | (g/100 g solid) | (g) | (g/100 g solution) |
| Deionized Water | | | 95.18 | 69.0 |
| Acrysol RM-825 | 0.74 | 3.11 | 2.64 | 1.91 |
| CoatOsil 1211 | 0.80 | 2.69 | 0.80 | 0.58 |
| Silwet L-77 | 0.30 | 1.26 | 0.30 | 0.22 |
| Novacryl DP-126 | 3.10 | 13.05 | 5.13 | 3.72 |
| (60.3% wet | | | | |
| weight) | | | | |
| Acrygen 8662 | 12.38 | 52.11 | 27.52 | 19.96 |
| Ancamine K-54 | 0.34 | 1.43 | 0.34 | 0.25 |
| CoatOsil 1770 | 1.05 | 4.42 | 1.05 | 0.76 |
| Diethylene- | 5.00 | 21.05 | 5.00 | 3.63 |
| glycolbutylether | | | | |
| TOTAL | 23.71 | | 137.9 | |

### Example 7

Antifungal treatment of a wooden surface: A composition comprising moringa oil and neem oil in a clear polymer vehicle was used to coat the surface of an untreated wooden surface of a fence exposed to the air. Control surfaces were untreated. The plates were exposed to sunlight and air and periodically examined for the extent of fungal colonization.

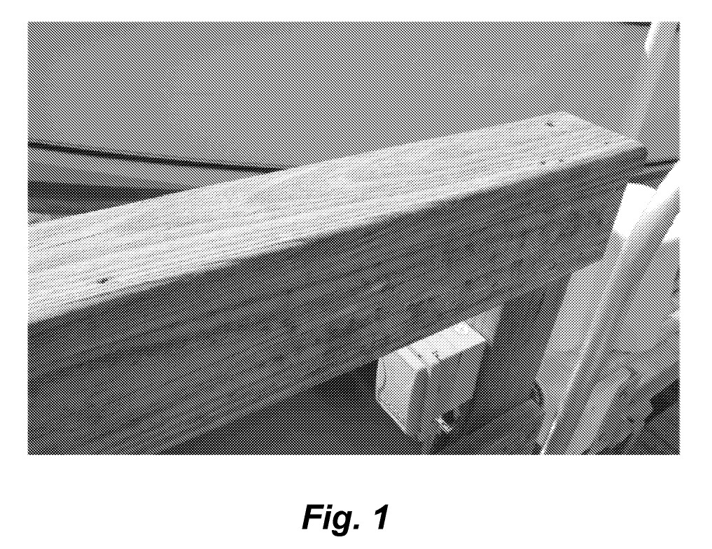

As shown in FIG. 1A, at the end of six months, the control surfaces were heavily infested with black fungal colonies. In contrast, however, the plates treated with the paint had very little or no visible fungal growth or discoloration.

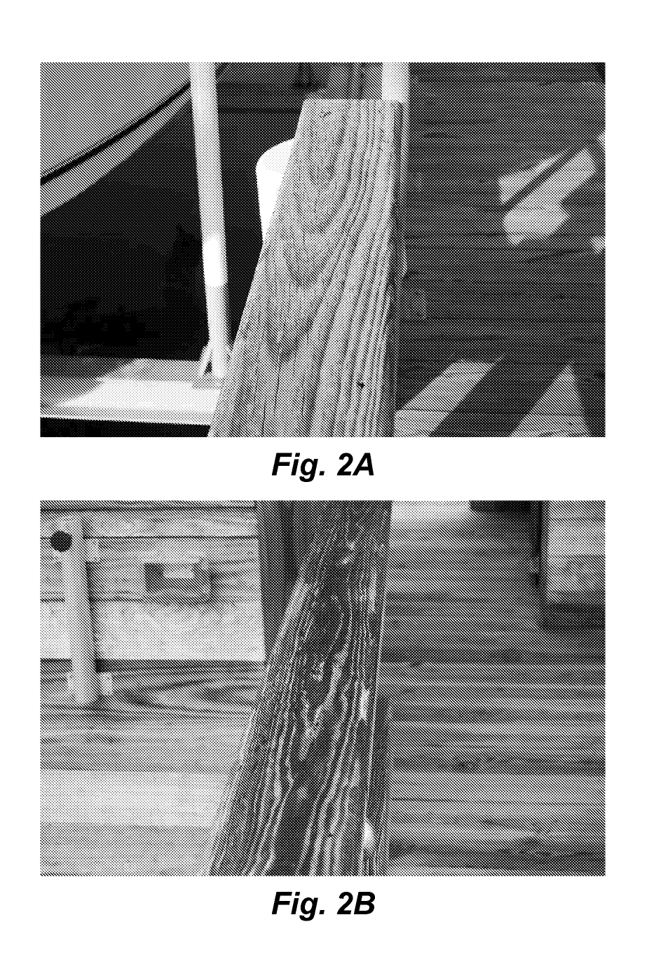

Similarly, more prolonged exposure of a treated wood surface (treated with a moringa oil-neem oil composition according to the disclosure) for as long as 26 months did not result in significant infestation of the exposed treated surface with fungi, as evidenced by the minimal presence of blackened fungal colonies (FIG. 2A). Untreated wooden surfaces in the same location, after 26 months, presented clear evidence of fungal infestation, as shown in FIG. 2B.

### Example 8

Antialgal treatment of a wooden surface: A composition comprising moringa oil and neem oil in a clear polymer vehicle was used to coat the surface of an untreated wooden surface exposed to seawater. A control surfaces was untreated. The samples were periodically examined for the extent of algal colonization.

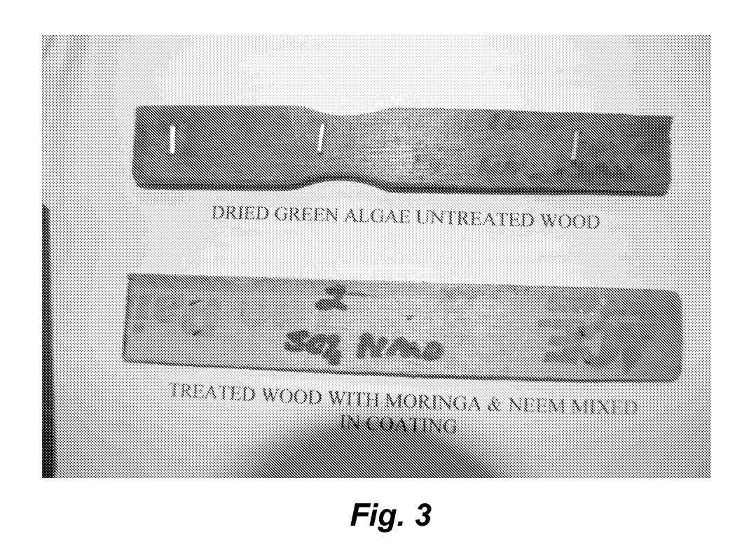

As shown in FIG. 3, at the end of six months, the control surfaces were heavily infested with an algal infestation. In contrast, however, the surfaces treated with the paint had very little or no visible growth or discoloration.

1. A bioactive composition comprising moringa oil and neem oil in a liquid or non-liquid vehicle in an amount sufficient to inhibit or prevent a biological infestation on a surface coated with said bioactive composition, wherein the biological infestation comprises a fungal species, an algal species, a bacterial species, or any combination thereof.

2. The bioactive composition of claim 1, wherein each of the moringa oil and the neem oil independently comprise between about 0.001% to about 30.0% by weight, of the composition.

3. The bioactive composition of claim 1, wherein the moringa oil and the neem oil are in a ratio of: between about 10:1 to about 1:10 by weight, between about 5:1 to about 1:5 by weight; or between about 2:1 to about 1:2 by weight.

4. The bioactive composition of claim 3, wherein the moringa oil and the neem oil are in a ratio of about 1:1 by weight.

5. The bioactive composition of claim 1 wherein said composition is a coating of a surface of an inanimate object.

6. (canceled)

7. The bioactive composition of claim 1, wherein the liquid or non-liquid vehicle is a paint.

8. The bioactive composition of claim 1 wherein said composition further comprises at least one of a binder in an amount effective to enhance adherence of said coat formed from said composition and a pigment or dye component in an amount effective to impart a color to said coat.

9. The bioactive composition of claim 1 comprising at least one liquid vehicle selected from the group consisting of an organic solvent, a thinner, a diluent, a plasticizer, and water, and wherein when the vehicle includes water the composition further comprises at least one surfactant.

10. The bioactive composition of claim 9, wherein said composition further comprises at least one of a wetting agent, a buffer, a rheology modifier, a defoamer, a catalyst, an anti-skinning agent, a light stabilizer, a corrosion inhibitor, a dehydrator, an electrical agent, and an anti-insect agent.

11. The composition of claim 5, wherein the coating is at least one of a paint and a clear coating, wherein each of the paint and the clear coating independently comprises a lacquer, a varnish, a shellac, a stain, a water repellent coating, or a combination thereof.

12. (canceled)

13. The bioactive composition of claim 1, wherein the non-liquid vehicle is an adhesive, a grouting mix, a solid or semi-solid polymer, an elastomeric polymer, an organic solid, or an inorganic solid.

14. (canceled)

15. The bioactive composition of claim 13, wherein the non-liquid vehicle is a flexible tape or sheet and optionally further comprising an adhesive layer, wherein the flexible sheet or tape and the optional adhesive each independently comprise an elastomeric polymer comprising moringa oil and neem oil in amounts sufficient to inhibit or prevent a biological infestation on at least one of a surface of the flexible tape or sheet, the adhesive layer, or within the adhesive layer.

16. The bioactive composition of claim 5, wherein the coating is a multi-coat system comprising a plurality of superimposed layers, wherein each layer independently comprises moringa oil, neem oil, or a mixture of moringa oil and neem oil.

17. The bioactive composition of claim 6, wherein the coating is an architectural coating, wherein the architectural coating comprises a wood coating, a masonry coating, an artist's coating, a grouting mix, or a combination thereof.

18. (canceled)

19. The bioactive composition of claim 8, wherein the binder comprises an oil, an alkyd, an oleoresinous binder, a fatty acid epoxide ester, a polyester binder, an urethane binder, a phenolic resin, an epoxy resin, a polyhydroxyether binder, an acrylic resin, a polyvinyl binder, a rubber resin, a bituminous binder, a polysulfide binder, a silicone binder, or a combination thereof.

20. The bioactive composition of claim 5, wherein the coating comprises a polyol, an amine, an epoxide, a silicone, a vinyl, a phenolic, a triacrylate, an alkyd resin, an amino resin, a blown oil, an epoxy resin, a polyamide, a polyvinyl resin, an amino resin a phenolic resin, a polyamide, a ketimine, an aliphatic amine, a cycloaliphatic epoxy binder, a polyol, an epoxide, a polyurethane comprising an isocyanate moiety, an alkyd, an urethane, or a combination thereof.

21. The composition of claim 9, wherein the solvent comprises at least one of a hydrocarbon, an oxygenated compound, a chlorinated hydrocarbon, a nitrated hydrocarbon, wherein the hydrocarbon is an aliphatic hydrocarbon, a cycloaliphatic hydrocarbon, a terpene, an aromatic hydrocarbon, or a combination thereof, the aliphatic hydrocarbon is at least one of a petroleum ether, pentane, hexane, heptane, isododecane, a kerosene, a mineral spirit, a VMP naphtha, the cycloaliphatic hydrocarbon is at least one of cyclohexane, methylcyclohexane, ethylcyclohexane, tetrahydronaphthalene, decahydronaphthalene, the terpene is at least one of wood terpentine oil, pine oil, α-pinene, β-pinene, dipentene, D-limonene, the aromatic hydrocarbon is at least one of benzene, toluene, ethylbenzene, xylene, cumene, a type I high flash aromatic naphtha, a type II high flash aromatic naphtha, mesitylene, pseudocumene, cymol, styrene, the oxygenated compound is an alcohol, an ester, a glycol ether, a ketone, an ether, and the alcohol is at least one of methanol, ethanol, propanol, isopropanol, 1-butanol, isobutanol, 2-butanol, tert-butanol, amyl alcohol, isoamyl alcohol, hexanol, methylisobutylcarbinol, 2-ethylbutanol, isooctyl alcohol, 2-ethylhexanol, isodecanol, cylcohexanol, methylcyclohexanol, trimethylcyclohexanol, benzyl alcohol, methylbenzyl alcohol, furfuryl alcohol, tetrahydrofurfuryl alcohol, diacetone alcohol, trimethylcyclohexanol.

22. A method of providing or enhancing resistance to a biological infestation or growth on a surface of an inanimate object, wherein the biological infestation or growth comprises a fungal species, an algal species, a bacterial species, or any combination thereof, said method comprising applying a coating on the surface of the inanimate object, wherein the coating comprises a film or liquid coating comprising moringa oil and neem oil, wherein each of the moringa oil and the neem oil are in amounts that synergistically inhibit the biological infestation or growth of the coated surface.

23. (canceled)

24. The method of claim 22 wherein the coating comprises a plurality of superimposed layers, each layer independently comprising a liquid or solid vehicle and moringa oil or neem oil.

25. (canceled)

26. The method of claim 22 wherein the inanimate object is at least partially porous, said method further comprising impregnating at least a portion of said object with the composition comprising moringa oil and neem oil.

27-28. (canceled)
